(19) United States
(12) Patent Application Publication
(10) Pub. No.: US 2020/0045406 A1
(43) Pub. Date: Feb. 6, 2020

(54) Speaker

(71) Applicant: AAC ACOUSTIC TECHNOLOGIES (SHENZHEN) CO., LTD., Shenzhen (CN)

(72) Inventors: Hongjian Hu, Shenzhen (CN); Shuai Li, Shenzhen (CN)

(21) Appl. No.: 16/524,174

(22) Filed: Jul. 29, 2019

(30) Foreign Application Priority Data
Aug. 1, 2018 (CN) 201821235757.9

(51) Int. Cl. H04R 1/28; H04R 9/06; H04R 9/02; H04R 7/18; H04R 7/12

(52) U.S. Cl. CPC H04R 1/288; H04R 9/06; H04R 7/127; H04R 7/18; H04R 9/025

(57) ABSTRACT

A speaker as disclosed by the present invention includes a vibration system and a magnetic circuit system located below the vibration system. The vibration system includes a diaphragm and a voice coil for driving the diaphragm to vibrate. The magnetic circuit system includes a magnet and a bottom wall for carrying the magnet. The speaker further includes a damping layer positioned on the bottom wall right below the voice coil.

### FIELD OF THE PRESENT DISCLOSURE

The present disclosure relates to the field of electro-magnetic transducers, more particularly to a speaker used in a portable electronic device.

### DESCRIPTION OF RELATED ART

A speaker, like a speaker, is a very important component equipped in a mobile phone for producing audible sounds. A speaker generally uses a diaphragm to produce vibration and further to generate sounds.

In order to adapt to miniaturization and multifunctional development of various audio equipment and information communication equipment, the speaker used in the equipment is more likely to be more miniaturized. The matching of other elements on the periphery of the loudspeaker is more compact. The vibration system and the magnetic circuit system of the speaker are directly connected with the sound quality of the speaker. The vibration system of a related speaker comprises a vibrating diaphragm and a voice coil assembly attached to the vibrating diaphragm. The magnetic circuit system comprises a yoke and a magnet arranged in the yoke. During the vibration of the voice coil assembly, exceeding power for driving the voice coil to vibrate will make the coil produce amplitude greater than expected, which will cause strike between the coil and the component under the coil, for example, the yoke. Therefore, an improved speaker is desired.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is an isometric and exploded view of a speaker in accordance with an exemplary embodiment of the present disclosure.

FIG. 2 is a top view of the speaker in FIG. 1.

FIG. 3 is a cross-sectional view of the speaker, taken along line A-A in FIG. 2.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby are only to explain the disclosure, not intended to limit the disclosure.

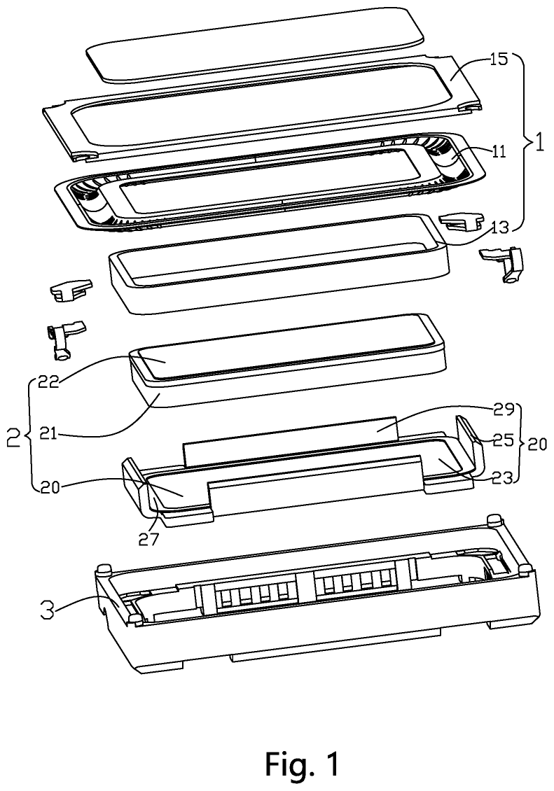

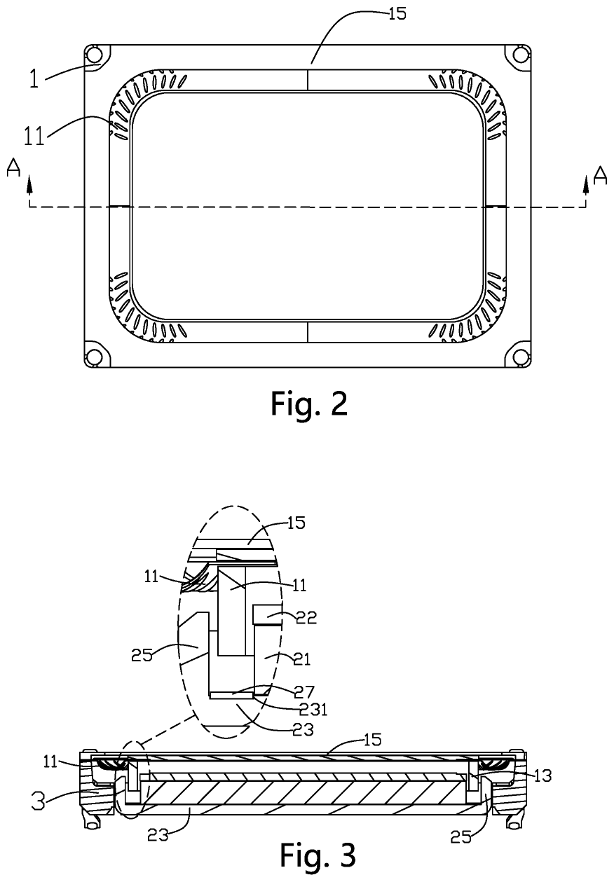

Referring to FIGS. 1-3, a speaker includes a vibration system 1, a magnetic circuit system 2 located below the vibration system 1, and a frame 3 for positioning the magnetic circuit system 2. The vibration system 2 includes a diaphragm 11 located on one side of the frame 3 and a voice coil 13 for driving the diaphragm 11. The magnetic circuit system 2 includes a magnetic yoke 20 fixed by the frame 3 and a magnet 21 carried by the magnetic yoke 20. The magnetic yoke 20 includes a bottom wall 23, a first side wall 25 and a second side wall 29 extending from the bottom wall 23 toward the vibration system 1.

For avoiding the potential direct strike produced between the voice coil 13 and the magnetic yoke 20, the speaker further includes a damping layer 27 mounted on the magnetic yoke 20.

Referring to FIG. 3, the damping layer 27 is mounted on the magnetic yoke corresponding to the voice coil 13. In the embodiment, the damping layer 27 is located right below the voice coil 13 and extends from a top surface of the bottom wall 23 toward the diaphragm 11. The damping layer 27 has a thickness for providing sufficient cushion to the voice coil 13. Optionally, the magnetic yoke 20 includes a recess 231 for positioning the damping layer 27.

An area of the damping layer 27 is greater than an area of a projection of the voice coil 13 along a vibration direction of the voice coil 13. In the embodiment, a projection of the voice coil 13 along the vibration direction of the voice coil 13 locates completely within the damping layer 27. During the vibration, the voice coil 13 will strike on the damping layer 27 when the power is exceeded, other than on the magnetic yoke 20.

The frame 3 further includes a plurality of posts at corners thereof. The vibration system 1 further includes a stiffness plate 15 stacked on the diaphragm 11. The magnet 21 includes a main magnet 231 located on the bottom wall 23 of the magnetic yoke 20. The main magnet 231 and the magnetic yoke cooperatively form a magnetic gap. A pole plate 22 is provided on the main magnet 231.

Further, the diaphragm 11 includes a dome and a suspension supporting the dome. An upper surface of the dome connects to the stiffness plate 15 and a lower surface of the dome connects to the voice coil.

Compared with the related art, the present invention provides a damping layer located between the voice coil and the magnetic yoke, which avoids the direct strike between the voice coil and the magnetic yoke. Accordingly, acoustic performance of the speaker is improved.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A speaker, comprising:
a vibration system including a diaphragm and a voice coil for driving the diaphragm to vibrate;
a magnetic circuit system located below the vibration system, including a magnet and a bottom wall for carrying the magnet;
a damping layer positioned on the bottom wall right below the voice coil.

2. The speaker as described in claim 1, wherein the damping layer extends from the bottom wall toward the diaphragm.

3. The speaker as described in claim 1, wherein a projection of the voice coil along a vibration direction of the voice coil locates completely within the damping layer.

4. The speaker as described in claim 1, wherein the bottom wall forms a recess for receiving the damping layer therein.

5. The speaker as described in claim 1, wherein the diaphragm includes a dome and a suspension supporting the dome.

6. The speaker as described in claim 5 further including a stiffness plate connecting the dome.
